(19) United States
(12) Patent Application Publication
(10) Pub. No.: US 2019/0188455 A1
(43) Pub. Date: Jun. 20, 2019

(54) CAPTURING AND USING FACIAL METRICS FOR MASK CUSTOMIZATION

(71) Applicant: KONINKLIJKE PHILIPS N.V., EINDHOVEN (NL)

(72) Inventors: ROBERT WILLIAM BAIKO, PITTSBURGH, PA (US); DANIEL STEED, NORTH HUNTINGDON, PA (US); RICHARD THOMAS HAIBACH, VERONA, PA (US)

(21) Appl. No.: 16/220,008

(22) Filed: Dec. 14, 2018

Related U.S. Application Data
(60) Provisional application No. 62/598,648, filed on Dec. 14, 2017.

(51) Int. Cl. G06K 9/00; G03B 17/56; G02B 26/08

(52) U.S. Cl. CPC G06K 9/00261; G02B 26/0816; G03B 17/565

(57) ABSTRACT

An apparatus for use with an electronic device in capturing facial metrics of a user of the electronic device, wherein the electronic device has a front facing camera facing the user and a rear facing camera facing away from the user. The apparatus includes a frame structured to be coupled to the electronic device and a number of reflective surfaces mounted to the frame. The number of reflective surfaces are positioned and structured such that the front facing camera may capture a first image of the user and the rear facing camera may capture a second image of the user simultaneously with the first image.

### CROSS-REFERENCE TO RELATED APPLICATIONS

This patent application claims the priority benefit under 35 U.S.C. § 119(e) of U.S. Provisional Application No. 62/598,648, filed on Dec. 14, 2017, the contents of which are herein incorporated by reference.

### BACKGROUND OF THE INVENTION

### 1. Field of the Invention

The present invention pertains to methods for identifying a custom mask for a patient for use in receiving a flow of a treatment gas to the airway of the patient. The present invention also pertains to systems for carrying out such methods.

### 2. Description of the Related Art

Many individuals suffer from disordered breathing during sleep. Sleep apnea is a common example of such sleep disordered breathing suffered by millions of people throughout the world. One type of sleep apnea is obstructive sleep apnea (OSA), which is a condition in which sleep is repeatedly interrupted by an inability to breathe due to an obstruction of the airway; typically the upper airway or pharyngeal area. Obstruction of the airway is generally believed to be due, at least in part, to a general relaxation of the muscles which stabilize the upper airway segment, thereby allowing the tissues to collapse the airway. Another type of sleep apnea syndrome is a central apnea, which is a cessation of respiration due to the absence of respiratory signals from the brain's respiratory center. An apnea condition, whether obstructive, central, or mixed, which is a combination of obstructive and central, is defined as the complete or near cessation of breathing, for example a 90% or greater reduction in peak respiratory air-flow.

Those afflicted with sleep apnea experience sleep fragmentation and complete or nearly complete cessation of ventilation intermittently during sleep with potentially severe degrees of oxyhemoglobin desaturation. These symptoms may be translated clinically into extreme daytime sleepiness, cardiac arrhythmias, pulmonary-artery hypertension, congestive heart failure and/or cognitive dysfunction. Other consequences of sleep apnea include right ventricular dysfunction, carbon dioxide retention during wakefulness, as well as during sleep, and continuous reduced arterial oxygen tension. Sleep apnea sufferers may be at risk for excessive mortality from these factors as well as by an elevated risk for accidents while driving and/or operating potentially dangerous equipment.

Even if a patient does not suffer from a complete or nearly complete obstruction of the airway, it is also known that adverse effects, such as arousals from sleep, can occur where there is only a partial obstruction of the airway. Partial obstruction of the airway typically results in shallow breathing referred to as a hypopnea. A hypopnea is typically defined as a 50% or greater reduction in the peak respiratory air-flow. Other types of sleep disordered breathing include, without limitation, upper airway resistance syndrome (UARS) and vibration of the airway, such as vibration of the pharyngeal wall, commonly referred to as snoring.

It is well known to treat sleep disordered breathing by applying a continuous positive air pressure (CPAP) to the patient's airway. This positive pressure effectively “splints” the airway, thereby maintaining an open passage to the lungs. It is also known to provide a positive pressure therapy in which the pressure of gas delivered to the patient varies with the patient's breathing cycle, or varies with the patient's breathing effort, to increase the comfort to the patient. This pressure support technique is referred to as bi-level pressure support, in which the inspiratory positive airway pressure (IPAP) delivered to the patient is higher than the expiratory positive airway pressure (EPAP). It is further known to provide a positive pressure therapy in which the pressure is automatically adjusted based on the detected conditions of the patient, such as whether the patient is experiencing an apnea and/or hypopnea. This pressure support technique is referred to as an auto-titration type of pressure support, because the pressure support device seeks to provide a pressure to the patient that is only as high as necessary to treat the disordered breathing.

Pressure support therapies as just described involve the placement of a patient interface device including a mask component having a soft, flexible sealing cushion on the face of the patient. The mask component may be, without limitation, a nasal mask that covers the patient's nose, a nasal/oral mask that covers the patient's nose and mouth, or a full face mask that covers the patient's face. Such patient interface devices may also employ other patient contacting components, such as forehead supports, cheek pads and chin pads. The patient interface device is typically secured to the patient's head by a headgear component. The patient interface device is connected to a gas delivery tube or conduit and interfaces the pressure support device with the airway of the patient, so that a flow of breathing gas can be delivered from the pressure/flow generating device to the airway of the patient.

Current state-of-the-art systems for creating a “custom” mask for a patient for use in delivering a flow of a treatment gas to the patient use 3-dimensional (3-D) scans which are obtained using expensive 3-D image capturing devices. As a result of the cost of such devices, access to such devices is generally limited.

### SUMMARY OF THE INVENTION

As one aspect of the invention an apparatus for use with an electronic device in capturing facial metrics of a user of the electronic device is provided. The electronic device has a front facing camera facing the user and a rear facing camera facing away from the user. The apparatus comprises: a frame structured to be coupled to the electronic device; and a number of reflective surfaces mounted to the frame, wherein the number of reflective surfaces are positioned and structured such that the front facing camera may capture a first image of the user and the rear facing camera may capture a second image of the user simultaneously with the first image.

The number of reflective surfaces may comprise a number of mirrors mounted to the frame.

The frame may comprise a securement mechanism structured to selectively couple the frame to the electronic device.

The frame may be structured to generally encompass a majority of the electronic device.

The number of reflective surfaces may comprise: a first reflective surface mounted to the frame such that the first reflective surface is structured to be disposed at a first angle with regard to the rear facing camera when the apparatus is positioned on the electronic device; and a second reflective surface mounted to the frame at a second angle perpendicular to the first angle.

The first reflective surface may be a portion of a first mirror mounted to the frame and the second reflective surface may be a portion of a second mirror mounted to the frame.

As another aspect of the invention, a system for capturing facial metrics of a user is provided. The system comprises: an electronic device having a front facing camera facing the user and a rear facing camera facing away from the user and an apparatus. The apparatus comprising: a frame coupled to the electronic device; and a number of reflective surfaces mounted to the frame, wherein the number of reflective surfaces are positioned and structured such that the front facing camera may capture a first image of the user and the rear facing camera may capture a second image of the user simultaneously with the first image.

The electronic device may comprise a smartphone or tablet.

The number of reflective surfaces comprises a number of mirrors mounted to the frame.

The frame may comprise a securement mechanism and the frame may be selectively coupled to the electronic device by the securement mechanism.

The frame may generally encompass a majority of the electronic device.

The number of reflective surfaces may comprise: a first reflective surface mounted to the frame such that the first reflective surface is structured to be disposed at a first angle with regard to the rear facing camera when the apparatus is positioned on the electronic device; and a second reflective surface mounted to the frame at a second angle perpendicular to the first angle.

The first reflective surface may be a portion of a first mirror mounted to the frame and wherein the second reflective surface is a portion of a second mirror mounted to the frame.

As yet another aspect of the invention, a method of determining facial metrics of a user of an electronic device having a front facing camera facing the user and a rear facing camera facing away from the user is provided. The method comprises: enabling both of the front facing camera and the rear facing camera to capture images at or near the same time; capturing a first image of the user using one of the front facing camera or the rear facing camera; capturing a second image of the user using the other of the front facing camera or the rear facing camera without moving the electronic device with respect to the user; and determining facial metrics of the user by analyzing the first image and the second image.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIGS. 1A and 1B, respectively, are isometric front and rear views of an electronic device in the form of a smartphone in accordance with one example embodiment of the present invention;

FIGS. 2A and 2B, respectively, are isometric front and rear views of a system for use in determining facial metrics of a user which includes the electronic device of FIGS. 1A and 1B shown with an apparatus for use in determining facial metrics of a user of the electronic device in accordance with one example embodiment of the present invention coupled to the electronic device;

FIG. 3 is a sectional view of the apparatus of FIGS. 2A and 2B taken along line 3-3 of FIGS. 2A and 2B; and

FIGS. 4A and 4B, respectively, are isometric front and rear views of a another system for use in determining facial metrics of a user which includes the electronic device of FIGS. 1A and 1B shown with an apparatus for use in determining facial metrics of a user of the electronic device in accordance with another example embodiment of the present invention disposed about and generally encompassing a majority of the electronic device.

### DETAILED DESCRIPTION OF EXEMPLARY EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As used herein, the statement that two or more parts or components “engage” one another shall mean that the parts exert a force against one another either directly or through one or more intermediate parts or components. As used herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

As used herein, the term “image” shall refer to a representation of the form of a person and may be in the form of electronic information describing the form.

Embodiments of the present invention utilize cameras on readily available electronic devices which have both front and rear-facing cameras, such as, for example, without limitation, most cellular smartphones and electronic tablets, to capture multiple images of a person/patient that are captured generally at the same time. Such images are then employed, using known techniques, to determine facial metrics of the patient which are then employed in determining, and further identifying, a custom mask for use by the patient in receiving a pressure support therapy.

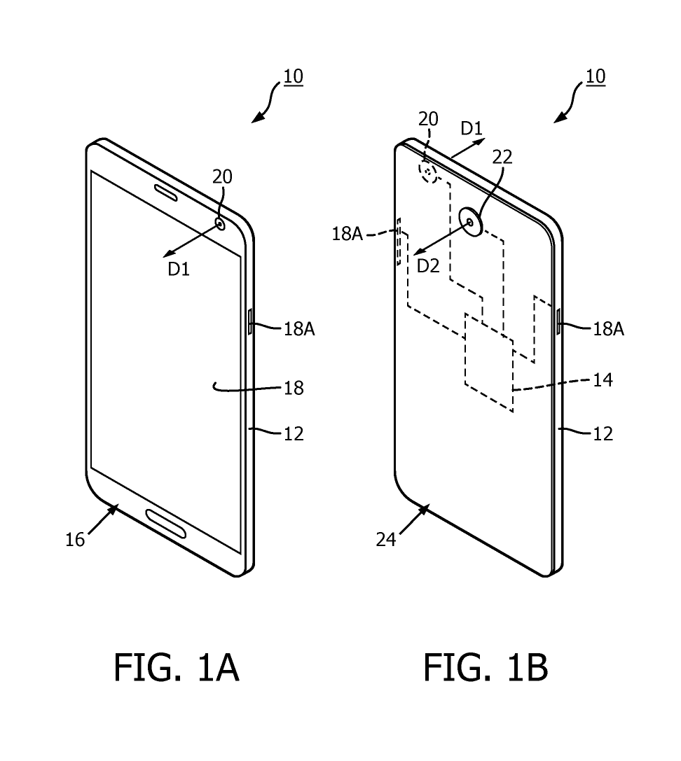

FIGS. 1A and 1B, respectively, show front and rear views of an example electronic device 10 in the form of a smartphone which may be employed with, or as an element of, example embodiments in accordance with the present invention. Electronic device 10 includes a housing 12 having various electronic components, including a suitable processing device 14 (shown schematically in hidden line in FIG. 1B) disposed therein. Electronic device 10 further includes an/input output device positioned on a front face 16 of housing 12 in the form of a touchscreen 18 for providing data to, or receiving output from, processing device 14. Further input devices, e.g., side buttons 18A and 18B, may also be provided in electrical communication with processing device 14 for providing indications to processing device for carrying out predetermined functions thereof. Electronic device 10 further includes a first image capturing device in the form of a front facing camera 20 positioned on front face 16 facing away from housing 12 in a first direction D1, and a second image capturing device in the form of a rear-facing camera 22 positioned on a rear face 24 of housing 12, opposite front face 16, facing away from housing 12 in a second direction D2 opposite first direction D1. Front and rear facing cameras 20 and 22 are electrically connected to processing device 14 such that cameras 20 and 22 are both controlled by, and communicate captured image data to, processing device 14. As will be described further below, processing device 14 is structured to selectively actuate either one, or both of cameras 20 and 22 either simultaneously or generally simultaneously (i.e., close enough in sequence so as to capture the subsequent image subject without movement by the subject between images).

Processing device 14 includes a processing portion which may be, for example, a microprocessor, a microcontroller or some other suitable processing device, and a memory portion that may be internal to the processing portion or operatively coupled to the processing portion and that provides a storage medium for data and software executable by the processing portion for controlling the operation of electronic device 10. The memory portion can be any of one or more of a variety of types of internal and/or external storage media such as, without limitation, RAM, ROM, EPROM(s), EEPROM(s), FLASH, and the like that provide a storage register, i.e., a machine readable medium, for data storage such as in the fashion of an internal storage area of a computer, and can be volatile memory or nonvolatile memory.

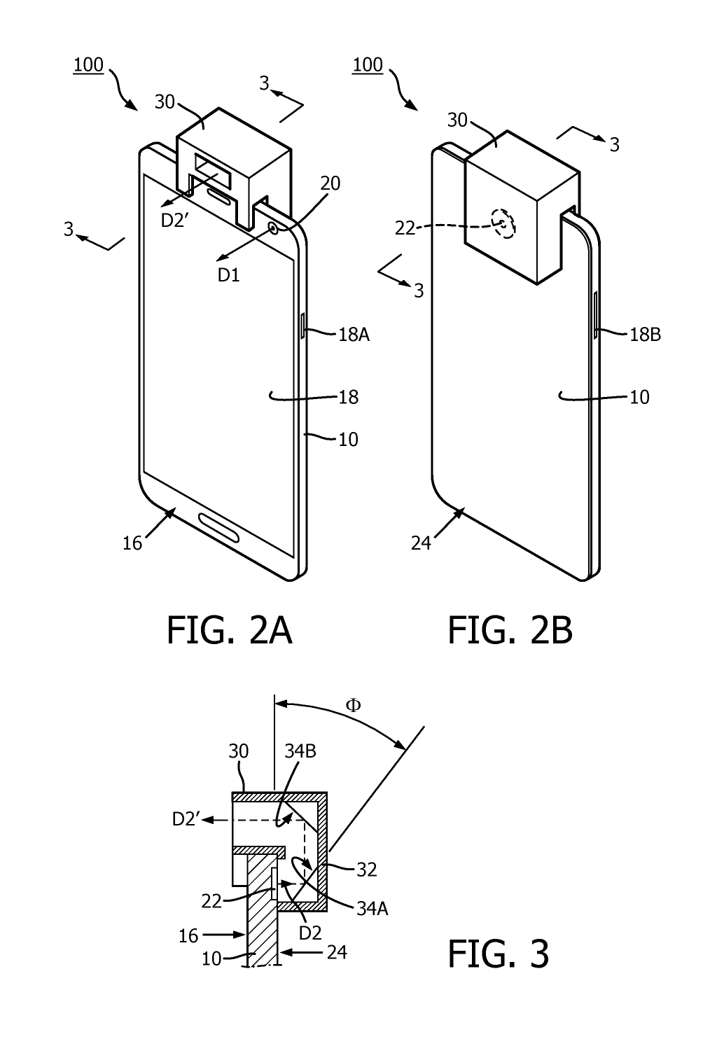

FIGS. 2A and 2B, respectively, are front and rear isometric views of the electronic device 10 of FIGS. 1A and 1B, shown with an apparatus 30 thus forming a system 100 for use in capturing facial metrics of a user of electronic device 10 according to one, exemplary embodiment of the present invention. Apparatus 30 includes a frame 32 structured to be coupled to electronic device 10 via any suitable coupling means (e.g., without limitation, a frictional fit, an adhesive, a spring-loaded clamping mechanism ,or any other suitable securement mechanism). As shown in the sectional view of FIG. 3, apparatus 30 includes a number (two are utilized in the example embodiment) of reflective surfaces 34A, 34B mounted to frame 32 which are positioned and structured such that rear-facing camera 22 is effectively aimed, such as shown by arrow D2′ in the same direction, i.e., first direction D1, as front facing camera 20. Accordingly, apparatus 30 thus provides for front facing camera 20 to capture a first image of a user of electronic device 10 equipped with apparatus 30 while also allowing rear facing camera 22 to capture a second image of the user at or about the same time as the first image without moving the phone whatsoever. Although two reflective surfaces 34A and 34B are employed in the example embodiment illustrated, it is to be appreciated that any number of surfaces may employed without varying from the scope of the present invention.

In the example embodiment illustrated in FIG. 3, reflective surfaces 34A and 34B were portions of mirrors mounted to frame 32. In such example, reflective surface 34A was mounted to frame 32 such that reflective surface 34A is disposed at a first angle ϕ with regard to rear facing camera 22 when apparatus 30 is positioned on electronic device 10. In such example embodiment second reflective surface 34B is mounted to frame 32 at a second angle (not labeled) perpendicular to the first angle.

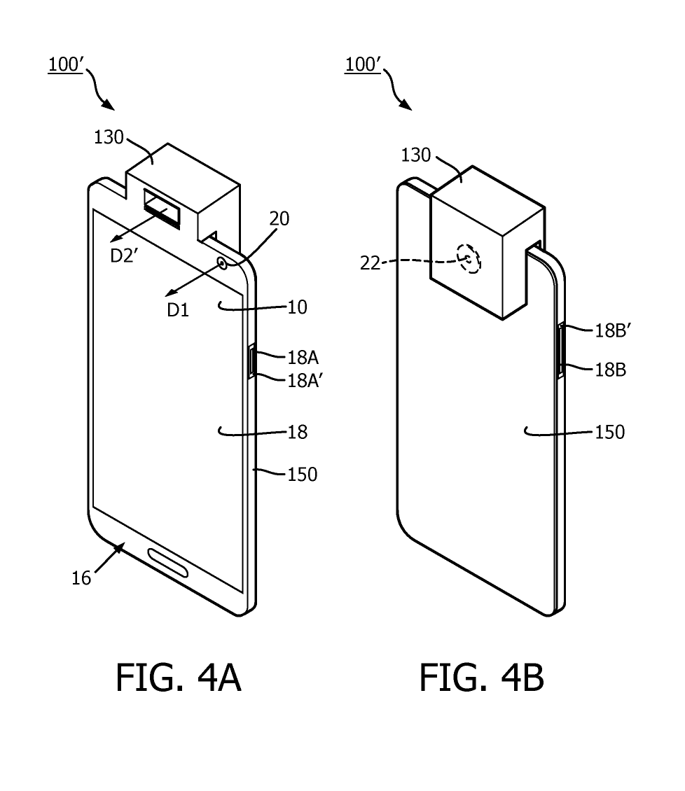

FIGS. 4A and 4B, respectively, are front and rear isometric views of the electronic device 10 of FIGS. 1A and 1B, shown with an apparatus 130 thus forming a system 100′ for use in capturing facial metrics of a user of electronic device 10 according to one, exemplary embodiment of the present invention. Apparatus 130 includes is of similar layout as apparatus 30 previously discussed in conjunction with FIGS. 2A, 2B and 3 except apparatus 130 is secured to electronic device 10 via a coupling portion 150 which is formed similar to a protective smartphone case which generally encompass a majority of electronic device 10.

Having thus described example embodiments of apparatuses 30 and 130, and systems 100 and 100′ including such apparatuses and an associated electronic device 10, use of as such systems in determining facial metrics of a user with such systems will be briefly described. As an initial step, a user of electronic device 10 would select a program which would enable both front facing camera 20 and rear facing camera 22 to capture images at or near the same time. Next, a first image of the user is captured using one of front facing camera 20 or rear facing camera 22 subsequently, or simultaneously, a second image of the user is captured using the other of front facing camera 20 or rear facing camera 22 without moving the electronic device with respect to the user. Finally, facial metrics of the user are determined by analyzing the first image and the second image. During such analysis, the first and second images may be stitched together and triangulated to construct a 3D geometry from which a custom CPAP mask for the user may be made or otherwise identified to the user. Alternatively, the 2D images could be used to create a 3-D spatial model using any number of other techniques known to one skilled in the art such as through the use of disparity maps in the epipolar plane, volumetric deep neural networks (DNN), or generative adversarial network correlations.

From the foregoing, it is to be appreciated that embodiments of the present invention provide for facial metrics of a user to be obtained through the use of a readily available electronic device such as a smartphone, tablet, or similar device without the need for an expensive 3D imaging device.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment. It is also to be appreciated that the overall and/or cross sectional shapes of structures described herein are provided for exemplary purposes only and that such shapes may be varied without varying from the scope of the present invention.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

What is claimed is:

1. An apparatus for use with an electronic device in capturing facial metrics of a user of the electronic device, the electronic device having a front facing camera facing the user and a rear facing camera facing away from the user, the apparatus comprising:
a frame structured to be coupled to the electronic device; and
a number of reflective surfaces mounted to the frame, wherein the number of reflective surfaces are positioned and structured such that the front facing camera may capture a first image of the user and the rear facing camera may capture a second image of the user simultaneously with the first image.

2. The apparatus of claim 1, wherein the number of reflective surfaces comprises a number of mirrors mounted to the frame.

3. The apparatus of claim 1, wherein the frame comprises a securement mechanism structured to selectively couple the frame to the electronic device.

4. The apparatus of claim 1, wherein the frame is structured to generally encompass a majority of the electronic device.

5. The apparatus of claim 1, wherein the number of reflective surfaces comprises:
a first reflective surface mounted to the frame such that the first reflective surface is structured to be disposed at a first angle (ϕ) with regard to the rear facing camera when the apparatus is positioned on the electronic device; and
a second reflective surface mounted to the frame at a second angle perpendicular to the first angle.

6. The apparatus of claim 5, wherein the first reflective surface is a portion of a first mirror mounted to the frame and wherein the second reflective surface is a portion of a second mirror mounted to the frame.

7. A system for capturing facial metrics of a user, the system comprising:
an electronic device having a front facing camera facing the user and a rear facing camera facing away from the user;
an apparatus comprising:
a frame coupled to the electronic device; and
a number of reflective surfaces mounted to the frame, wherein the number of reflective surfaces are positioned and structured such that the front facing camera may capture a first image of the user and the rear facing camera may capture a second image of the user simultaneously with the first image.

8. The system of claim 7, wherein the electronic device comprises a smartphone or tablet.

9. The system of claim 7, wherein the number of reflective surfaces comprises a number of mirrors mounted to the frame.

10. The system of claim 7, wherein the frame comprises a securement mechanism and wherein the frame is selectively coupled to the electronic device by the securement mechanism.

11. The system of claim 7, wherein the frame generally encompasses a majority of the electronic device.

12. The system of claim 7, wherein the number of reflective surfaces comprises:
a first reflective surface mounted to the frame such that the first reflective surface is structured to be disposed at a first angle (ϕ) with regard to the rear facing camera when the apparatus is positioned on the electronic device; and
a second reflective surface mounted to the frame at a second angle perpendicular to the first angle.

13. The system of claim 12, wherein the first reflective surface is a portion of a first mirror mounted to the frame and wherein the second reflective surface is a portion of a second mirror mounted to the frame.

14. A method of determining facial metrics of a user of an electronic device having a front facing camera facing the user and a rear facing camera facing away from the user, the method comprising:
enabling both of the front facing camera and the rear facing camera to capture images at or near the same time;
capturing a first image of the user using one of the front facing camera or the rear facing camera;
capturing a second image of the user using the other of the front facing camera or the rear facing camera without moving the electronic device with respect to the user; and
determining facial metrics of the user by analyzing the first image and the second image.
